(19) United States
(12) Patent Application Publication
(10) Pub. No.: US 2009/0079567 A1
(43) Pub. Date: Mar. 26, 2009

(54) SECURING AN ARTICLE OF VALUE

(76) Inventor: Chirag Vithalbhai Patel, San Mateo, CA (US)

Correspondence Address: HAHN AND MOODLEY, LLP, P.O. BOX 52050, MINNEAPOLIS, MN, 55402, US

(21) Appl. No.: 11/858,884

(22) Filed: Sep. 20, 2007

(51) Int. Cl. G08B 13/14

(52) U.S. Cl. 340/572.1

(57) ABSTRACT

Embodiments of the invention disclose a mobile device, such as a mobile phone, that is capable of causing an alarm to be played to a user, to prevent a loss thereof. Advantageously, the mobile device also moves to a locked state in anticipation of being lost, thereby to prevent unauthorized use thereof. In a further embodiment, an accessory device is provided. The accessory device can be secured to an article of value that does not natively have radio capability. The accessory device is able to send a control signal to a tag carried on a person of a user, which control signal causes the tag to sound an alarm to notify the user of a potential loss of the article of value.

### FIELD

Embodiments of the invention relate to securing an article of value.

### BACKGROUND

As personal electronic devices become more integrated into daily life, concomitantly the impact caused by their loss increases. The loss of a personal electronic device is not just the loss of the device itself (which is frequently expensive), but also the loss of valuable, and possibly irreplaceable, information contained in the device, which can be catastrophic. Furthermore, identity thieves can use the information contained in a lost or stolen device for fraudulent purposes.

### SUMMARY

Embodiments of the invention disclose a mobile device, such as a mobile phone, that is capable of causing an alarm to be played to a user, to prevent a loss thereof. Advantageously, the mobile device also moves to a locked state in anticipation of being lost, thereby to prevent unauthorized use thereof.

In a further embodiment, an accessory device is provided. The accessory device can be secured to an article of value that does not natively have radio capability. The accessory device is able to send a control signal to a tag carried on a person of a user, which control signal causes the tag to sound an alarm to notify the user of a potential loss of the article of value.

Other aspects of the present invention will become apparent from the detailed description below.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 shows a high-level block diagram of a personal electronic device, in accordance with one embodiment of the invention;

FIG. 2 illustrates an organization for a memory for the personal and electronic device of FIG. 1, in accordance with one embodiment of the invention;

FIG. 3 shows the personal electronic device of FIG. 1 comunicatively coupled to a tag 30, in accordance with one embodiment of the invention;

FIG. 4 shows a high-level block diagram of a tag, in accordance with one embodiment of the invention; and

FIG. 5 shows an accessory device comunicatively coupled to a tag 30, in accordance with one embodiment of the invention

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration, one skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose techniques for securing an article of value such a mobile phone or a book (in non-electronic form) A personal electronic device embodying the techniques is also disclosed. Finally, an accessory device that can be secured to an article of value and embodying the techniques is disclosed.

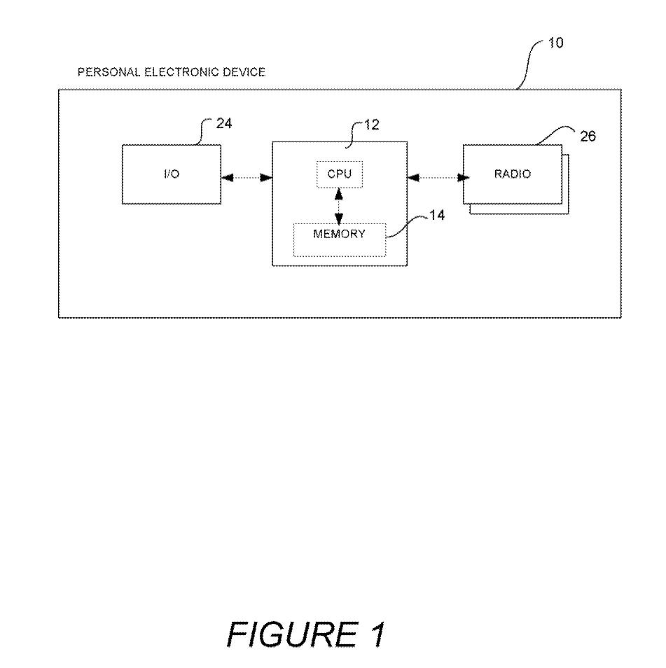

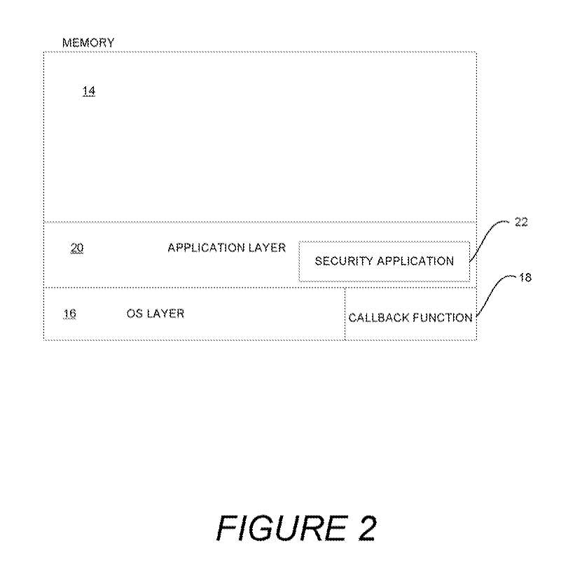

FIG. 1 of the drawings shows an article of value comprising a personal electronic device in the form of a mobile telephone 10. The telephone 10 comprises a central processing unit (CPU) 12 which is coupled to a memory 14. FIG. 2 of the drawings shows an organization for the memory 14, in accordance with one embodiment of the invention. Referring to FIG. 2, it will be seen that the memory 14 comprises an operating system (OS) layer 16. The OS layer 16 implements a callback function 18, which provides callback functionality to an application layer 20 as will be described. Typically, the application layer 20 comprises multiple applications for operating the mobile device 10. In accordance with one embodiment, the application layer 20 comprises a security application 22 for practicing the techniques of securing the mobile device 10 as will be described. Continuing with FIG. 1 of the drawings, the mobile device 10 further comprises several input/output (I/O) devices 24 such as, for example a display, a keyboard, a scroll wheel etc. The mobile device 10 also includes one or more radios 26 to enable wireless communications. For example, the mobile device may comprise a Bluetooth radio, and/or a Wi-Fi radio, in accordance with different embodiments.

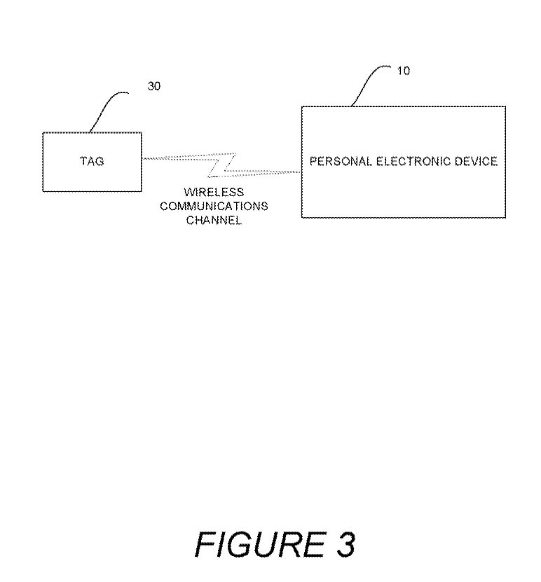

In embodiments of the invention, the mobile device 10 may be communicatively coupled with a tag 30, as can be seen in FIG. 3 of the drawings. The coupling between the mobile device 10 and the tag 30 is achieved through a wireless communications channel such as a Bluetooth communications channel. Thus, for this embodiment, the tag 30 includes a Bluetooth radio. In accordance with embodiments of the invention, the tag 30 may be a dedicated tag comprising only a Bluetooth radio for purposes of coupling with the mobile device 10 in order to practice the techniques of the invention. In other cases, the tag 30 may be a Bluetooth headset, or even some other portable electronic device such as an MP3 player that is carried on the person of a user.

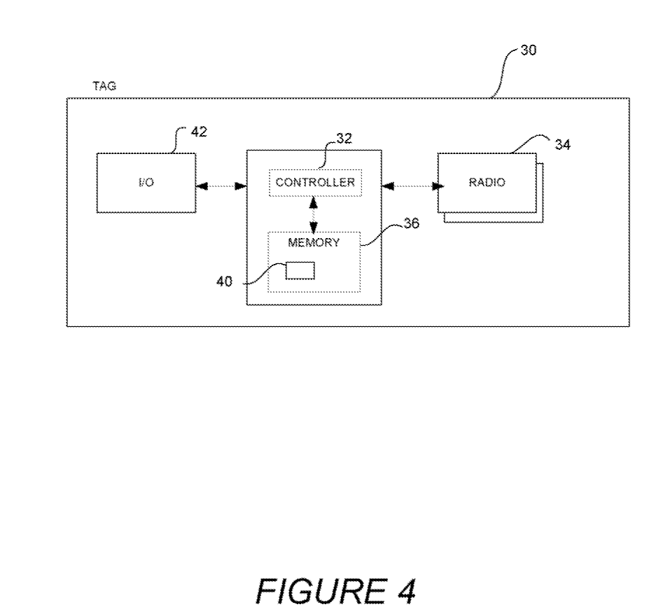

Architecturally, the tag 30 comprises a controller 32 coupled to a wireless radio 34, which may be a Bluetooth radio, in one embodiment, as can be seen in FIG. 4 of the drawings. The tag also includes a memory 36, and one or more I/O devices 38, each coupled to the controller 32. In one embodiment, the memory 36 implements logic to trigger an alarm (e.g. produce an audible sound) responsive to a control signal from the device 10. In some cases, said logic may trigger the alarm based on a loss of a communications link with the device 10 without any explicit control signal from the device 10.

In one embodiment, the mobile device 10 may be such that the callback function 18 provides callback information to the security application 22 regarding a state of a Bluetooth communications link. With this mechanism, the security application 22 is able to detect a loss of the Bluetooth communications link with the tag 30. In one embodiment, a detection unit implemented in the security application 22 detects an alarm condition. In accordance with different embodiments of the invention, the alarm condition may comprise a loss of the Bluetooth communications link with the tag 30, or a distance between the mobile device 10 and the tag 30 reaching a predefined distance. As noted above, in one embodiment, the loss of the Bluetooth communications channel with the tag 30 may be determined based on a callback from the operating system 18 when a Bluetooth link with the tag 30 is lost. However, in cases where the operating system 18 provides no such callback capability, the detection unit implemented in the security application 22 sends, or at least attempts to send a data packet over a Bluetooth communications link with the tag 30, in accordance with the Bluetooth protocol. If an acknowledgement responsive to the data packet is received from the tag 30 then the communications link with the tag is operational. Failure to receive such an acknowledgement is interpreted as a failure or los of the communications link with the tag 30, in one embodiment.

For detecting when the mobile device 10 and the tag 30 have reached the predefined distance, in one embodiment, while the Bluetooth communications link between the mobile device 10 and the tag 30 is established, the detection unit periodically sends data packets to the tag 30, which the tag acknowledges. Given the time taken to the receive a response packet from the tag 30, and latency in processing the response packet within the tag 30, it is possible, in one embodiment of the invention, to calculate the over-the-air (OTA) travel time for the data packet between the mobile device 10 and the tag 30. Given the over-the-air travel time, it is possible to calculate the distance between the mobile device 10 and the tag 30. In one embodiment, the predefined distance may be set to a meaningful number, such as 10 meters. In this case, when the distance between the mobile device 10 and the tag 30 reaches 10 meters, the detection unit will detect the alarm condition. Based on the detection of the alarm condition, which as noted above may be either the distance between the mobile device 10 and the tag 30 reaching a predefined distance, or a loss of the Bluetooth communications channel between the mobile device 10 and the tag 30, a control unit implemented as a module within the security application 22 moves the mobile device 10 to a locked state. In the locked state, an unauthorized user will not have access to valuable data in the mobile device 10, nor will the unauthorized user be able to operate the mobile device 10. From its unlocked state, information such as a password will be required to move the mobile device 10 back to its unlocked state. Additionally, the control unit also sends a control signal to the tag 30 before moving the mobile device to the locked state. The control signal, when received by the tag, causes the tag to trigger an alarm. In accordance with different embodiments of the invention, the alarm may be an audible alarm which when heard by the user alerts the user to the fact that the mobile device has been left behind.

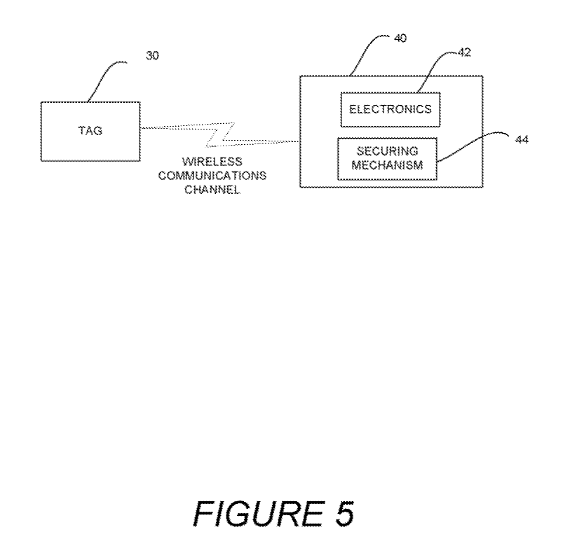

For securing articles of value that do not natively have radio capability, for example a valuable book, an accessory device 40 (see FIG. 5 of the drawings) is provided. The accessory device 40 includes electronic 42 similar to the electronics of the device 10 to communicate with the tag 30 and to send a control signal to the tag 30 to cause an alarm to be trgiggered, as described above. Additionally, the device 40 includes a securing mechanism 44 by which the accessory device may be secured to an article of value such as a book. In one embodiment the securing mechanism may comprise straps with Velcro fasteners. The device may be secured to an article of value that does not have native radio capability such as a book in order to prevent a loss thereof, in accordance with the techniques described above.

In general, the routines executed to implement the embodiments of the invention may be implemented as part of an operating system or a specific application, component, program, object, module or sequence of instructions referred to as “computer programs.” The computer programs may be implemented in software or in hardware. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

1. A method, comprising:
detecting when a user has moved a predefined distance from a mobile device; and
automatically locking the mobile device to prevent unauthorized access thereto, if a user has moved the predefined distance.

2. The method of claim 1, wherein the detecting is based on a round-trip travel time of the data packets sent from the mobile device to a tag associated with the mobile device.

3. The method of claim 2, further comprising sending a control signal to the tag if the user has moved the predefined distance, the control signal to cause the tag to trigger an alarm to remind the user to retrieve the mobile device.

4. The method of claim 1, wherein the predefined distance comprises an operating range for a short range communications protocol.

5. A device, comprising:
a wireless radio;
a detection unit to detect an alarm condition; and
a control unit to lock to send a control signal to the tag to trigger an alarm in the tag.

6. The device of claim 5, which is a mobile phone.

7. The device of claim 5, which is an accessory device that can be attached to an article of value.

8. The device of claim 6, wherein the control unit further locks the mobile phone to prevent unauthorized access thereto.

9. The device of claim 5, wherein the tag comprises a headset that is communicatively coupled with the device.

10. The device of claim 9, wherein the alarm condition comprises a loss the communicative coupling between the device and the tag.

11. The device of claim 5, wherein the alarm condition comprises a predefined distance being reached between the mobile device and the tag.

13. A tag, comprising:
a wireless radio; and
a control unit to trigger an alarm to serve as a reminder to retrieve an associated article of value.

14. The tag of claim 13, which is in the form of a wireless headset capable of being communicatively coupled with the article of value.

15. The tag of claim 14, wherein the article of value comprises a mobile phone.

16. The tag of claim 13, wherein the control unit triggers the alarm condition when communicative coupling with the article of value is lost.

17. The method of claim 13, wherein the tag is in the form of a keychain.

18. The method of claim 13, wherein the alarm is an audible alarm.
